(19) United States
(12) Patent Application Publication
(10) Pub. No.: US 2006/0172586 A1
(43) Pub. Date: Aug. 3, 2006

(54) Electrical test lead connector

(76) Inventor: Shane Rosenblatt, Salem, OR (US)

Correspondence Address: KLARQUIST SPARKMAN, LLP, 121 SW SALMON STREET, SUITE 1600, PORTLAND, OR, 97204, US

(21) Appl. No.: 11/343,620

(22) Filed: Jan. 30, 2006

Related U.S. Application Data
(60) Provisional application No. 60/648,331, filed on Jan. 28, 2005.

(51) Int. Cl. H01R 4/24

(52) U.S. Cl. 439/425

(57) ABSTRACT

Disclosed is a test lead attachment device including a housing that defines a port into which a port pin may be inserted for electrical connection to the conductor of an insulated wire. A test probe may be connected to the port pin to electrically connect the conductor to a voltmeter or other electrical testing instrument.

### CROSS-REFERENCE TO RELATED APPLICATION

This application claims the benefit of U.S. Provisional Application No. 60/648,331, filed Jan. 28, 2005, entitled “Electrical Test Lead Connector,” the disclosure of which is hereby incorporated by reference.

### BACKGROUND AND SUMMARY

The present invention relates to methods and devices for measuring properties of electrical circuits.

Electrical testing involving wires has been accomplished in many different ways throughout the years. Oftentimes, a wire needs to be accessed by a testing instrument, such as a voltmeter. One of the ways this has been done has been to strip a portion of insulation that surrounds the wire, thereby revealing a segment of the inner conductive portion of the wire. Such inner portion is usually metallic in nature and the portion of the wire responsible for carrying electricity. A test probe can then be held against the exposed segment or, alternatively, a test lead clip can be attached to the segment. Such techniques have significant disadvantages, however, because they result in physical damage to the wire that is not easily fixable in that the stripped insulation usually cannot be readily replaced. Such techniques also lead to other issues. For example, holding a test probe against an exposed segment requires the devotion of one hand to that task while limiting the number of wires that a test probe may be coupled with. Test clips, once secured, may provide hands-free operation but typically are expensive and do not avoid the problems result when an area of insulation is removed.

Thus there is a need for an electrical test lead connector capable of providing convenient, non-destructive access to a wire to be contacted for testing purposes.

An improved testing device for connecting a test lead to a wire includes a housing that defines a port into which a port pin may be inserted to be electrically connected to the wire. A test probe may then be connected to the port pin, providing an electrical connection with the conductive portion of the wire and a voltmeter or other electrical measurement instrument.

### BRIEF DESCRIPTION OF THE DRAWINGS

In the drawings:

FIG. 1 is an oblique view of a testing device attached to a wire.

FIG. 2 is a second oblique view of the device shown in FIG. 1, with a test lead inserted into a port that extends through a portion of the device to make electrical contact with the wire through the wire's insulation.

FIG. 3 is a vertical cross-sectional view of the device of FIG. 1 in an open position.

FIG. 4 is a vertical cross-sectional view of the device of FIG. 1 attached to a wire with a port pin partially inserted into a port that extends through a portion of the device.

FIG. 5 is a vertical cross-sectional view of the device of FIG. 1 with a port pin fully inserted into a port that extends through a portion of the device, thereby providing for electrical coupling between the wire and a test probe.

FIG. 6 is a schematic diagram of a testing system that includes two insulated electrical wires to be engaged, each with a testing device attached to provide electrical coupling with test probes of a testing instrument.

FIG. 7 is a vertical cross-sectional view of a second testing device.

FIG. 8 is an oblique view of a third testing device attached to a wire.

FIG. 9 is a second oblique view of the testing device of FIG. 8, with the testing device in an opened position and a wire inserted into the testing device.

FIG. 10 is a vertical cross-sectional view of the testing device of FIG. 8.

FIG. 11 is an oblique view of a fourth testing device, having a capping device.

FIG. 12 is a second oblique view of the testing device of FIG. 11.

FIG. 13 is a third oblique view of the testing device of FIG. 11 showing the capping device covering the port of the testing device.

### DETAILED DESCRIPTION

In the following description of the disclosed technology, reference is made to the accompanying drawings which form a part hereof, and in which are shown by way of illustration specific embodiments in which the invention may be practiced. Other embodiments may be utilized and structural changes may be made without departing from the scope of the disclosed technology.

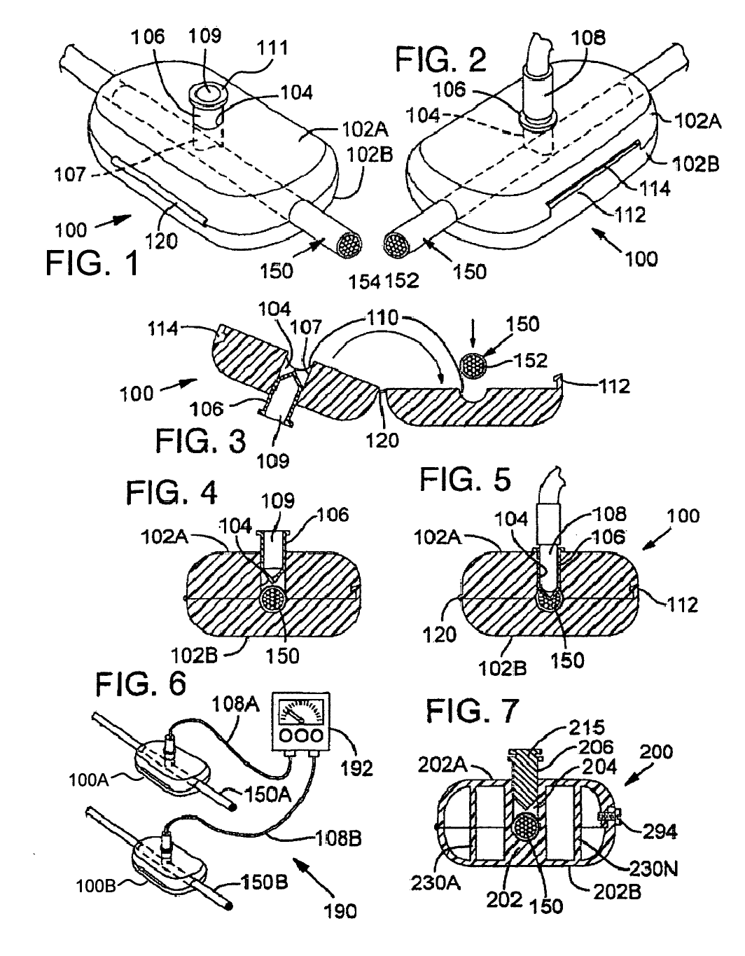

FIG. 1 shows a testing device 100 attached to an insulated wire 150. The testing device 100 includes a housing 102 of a generally clamshell configuration, which is shown in a closed position securely attached to the wire 150. A clamshell configuration generally allows for at least two positions: an open position and a closed position. The housing consists of two components 102A, 102B, that may or may not be symmetrical in shape. A port pin 106 is shown partially inserted into an access port 104 defined by the housing 102. The port pin 106 is configured to fit snugly into the access port 104. The port pin 106 is also configured to receive a test probe. For example, the illustrated port pin 106 has a generally cylindrical, axially extending inner wall that provides a socket 109 that is sized and shaped to receive a test probe 108. For most convenient operation, the socket of the port pin 106 can be sized and shaped to hold a test probe in place by frictional contact. A spring-loaded member (not shown) could be provided in the socket to apply a radially inwardly directed force against the probe 108 and thereby enhance frictional contact. In the illustrated device, the outer surface of the port pin 106 is generally cylindrical but tapers to a point at one end. A flange 111 extends radially outwardly from the port pin 106 at the other end. The housing 102 is made of a plastic material, the port pin 106 is made of a conductive material such as steel, aluminum, or other conductive metal. The access port 104 is a hole defined by a cylindrical wall 107 that extends through one component 102A of the housing 102. The port pin 106 may have a non-conductive material (e.g., Teflon or plastic) covering exposed portions, such as the flange 111, so as to prevent a shorting out on any nearby metal that may come in unintended contact with the port pin 106. A hinge 120 connects edges of the two components 102A, 102B of the housing 102.

FIG. 2 shows the testing device 100 with the port pin 106 fully inserted into the port 104. The test lead 108 has been inserted into the port pin 106 to make electrical contact with the wire 150 via the port pin 106. The test lead 108 is able to make such electrical contact because the port pin 106 extends through the insulation 152 of the wire 150 and electrically contacts the metallic strands 154 of the wire 150.

FIGS. 3-6 illustrate operation of the device. FIG. 3 shows the testing device 100 with its housing 102 in an open position. The wire to be contacted 150 may be placed in a groove 110 defined in by the housing 102, after which the two components 102A, 102B of the housing 102 may be moved to a closed position as shown in FIGS. 4-5, so that the groove 110 holds the wire 150 in alignment with the port 104. The housing 102 is held in the closed position by a fastening device. In particular, a detent 112 in one component of the housing 102 can be received by a receptacle 114 defined by the surface of the other component of the housing to hold the housing 102 in the closed position. Depending on the configuration of the detent and receptacle, the housing may easily be reopened for removal of the test device so that the device may be reused; or the housing, once snapped shut, may permanently grasp the wire such that the device must be destroyed for removal.

When the housing 102 is in a closed position, the port pin 106 may be inserted into the port 104 to pierce the insulation 152 of the wire 150. FIG. 4 shows the testing device 100 attached to the wire 150 with the port pin 106 partially inserted into the port 104. FIG. 5 shows the testing device 100 with the port pin 106 fully inserted, thereby electrically connecting the conductor of the wire 150 and the test probe 108.

FIG. 6 illustrates two such testing devices 100A, 100B in use in a testing system 190 that includes two wires 150A, 150B to be engaged for testing, each with a testing device 100A, 100B attached to provide electrical coupling with test probes 108A, 108B that are electrically connected to a testing instrument 192, such as a multimeter.

FIG. 7 shows a testing device 200 of a somewhat different construction. The testing device 200 includes a housing 202 having components 202A, 202B that are partially hollow and have several ribs 230A-N for strength. Such a housing is readily constructed using injection molding techniques. A port pin 206 is inserted into an access port 204. The port pin illustrated in FIG. 7 does not contain a socket into which a test probe may be inserted, but instead has a knob 215 to which an alligator clip can be clamped for attaching an electrical lead. A screw 294 extends through the first component 202A and into the second component 202B to fasten the two components together and maintain the housing 202 a closed position.

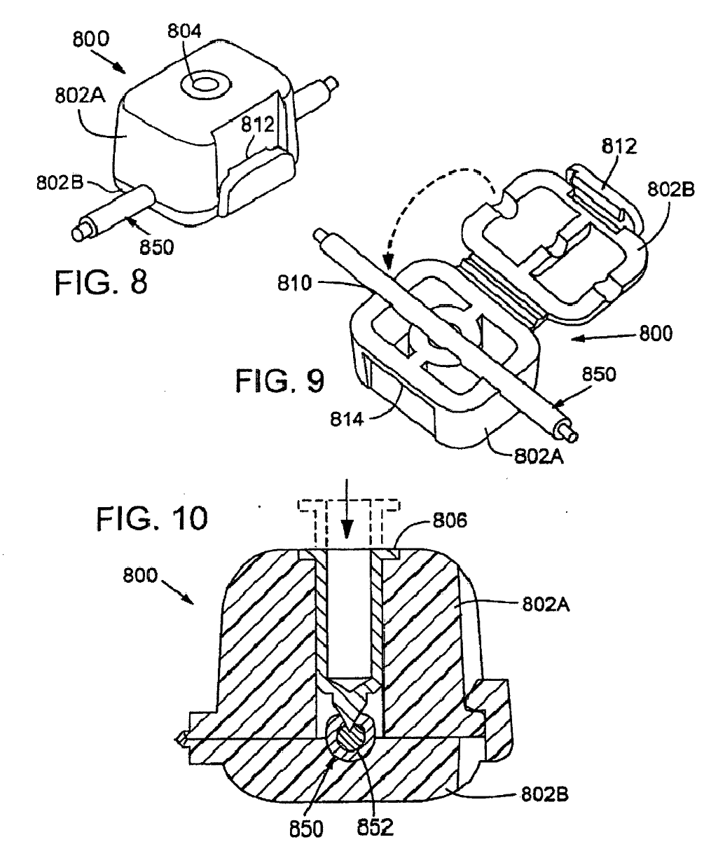

FIGS. 8-10 show a testing device 800 attached to an insulated wire 850. The testing device 800 includes a housing 802 of a generally clamshell configuration, which is shown in a closed position securely attached to the wire 850. The housing consists of two components 802A, 802B, that are not symmetrical in shape. An access port 804 is defined by the housing 802. A port pin 806 is configured to fit snugly into the access port 804. The port pin 806 also is configured to receive a test probe. For most convenient operation, the socket of the port pin can be sized and shaped to hold a test probe in place by frictional contact. A spring-loaded member (not shown) could be provided in the socket to apply a radially inwardly directed force against the probe and thereby enhance frictional contact. The outer surface of the port pin 806 is generally cylindrical and desirably tapers to a point at one end. The housing 802 can be made of any suitable material, such as an electrical insulator with plastic being an example. At least a portion of the port pin 806 is an electrical conductor and may be metallic. The access port 804 in a desirable configuration shown is a hole defined by a cylindrical wall that extends through one component 802A of the housing 802. The port pin may have a non-conductive material (e.g., Teflon or plastic) incorporated into its top so as to prevent a shorting out on any nearby metal that may come in unintended contact with the port pin. A hinge connects edges of the two components 802A, 802B of the housing 802.

FIGS. 9 and 10 illustrate operation of the device. FIG. 9 shows the testing device 800 with its housing 802 in an open position. The wire 850 may be placed in a wire guide or positioner such as a groove 810 defined in by the housing 802, after which the two components 802A, 802B of the housing 802 may be moved to a closed position as shown in FIG. 10, so that the groove 810 holds the wire 850 in alignment with the port 804. The housing 802 is desirably held in the closed position by a fastening device. In one particular example, a detent 812 in one component of the housing 802 can be received by a receptacle 814 defined by the surface of the other component of the housing to hold the housing 802 in the closed position. Depending on the configuration of the detent and receptacle, the housing may easily be reopened for removal of the test device so that the device may be reused; or the housing, once snapped shut, may permanently grasp the wire.

When the housing 802 is in a closed position, the port pin 806 (see FIG. 10) may be inserted into the port 804 to pierce the insulation 852 of the wire 850. Additionally, a cover (not shown) made of a non-conductive material (e.g., plastic) may be placed over the port pin 806 so as to block access to the socket provided by the illustrated form of the port pin 806 (e.g., when not in use). Such a cover may be separate from the housing 802 or, alternatively, may be connected to the housing 802 (e.g., a flap connected by a hinge).

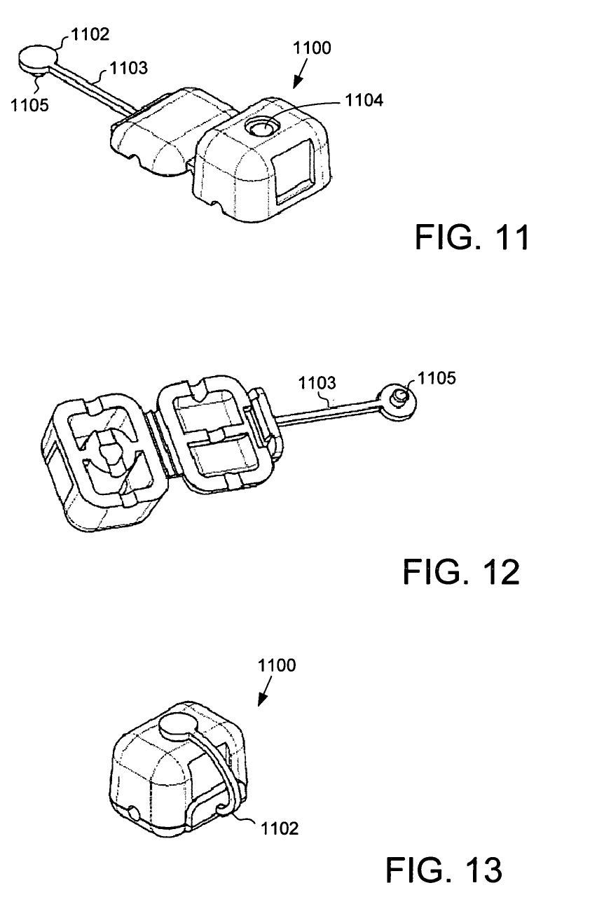

FIGS. 11-13 show a testing device 1100 with a capping device 1102. In the illustrated embodiment, the capping device 1102 includes an arm 1103 attached to the testing device 1100. In other embodiments, however, the capping device 1102 may be separate from the testing device 1100. A port 1104 in the testing device may receive a port pin (not shown). The capping device 1102 may engage the port 1104 directly or indirectly (such as, for example, through a port pin) to cover the opening of the port, as illustrated in FIG. 13. In the illustrated testing device, the capping device 1102 has a plug 1105 that is sized and shaped to frictionally engage an interior wall that defines the test lead socket of a port pin. Pressing the plug into the socket secures the capping device 1102 by friction such that the capping device 1102 is positioned over the opening of the port to serve as a cover. One of the many advantages this engagement provides is the protection of the opening from intrusion of foreign objects (e.g., dirt and water) that would otherwise find their way into the port. The capping device 1102 is preferably made of a non-conductive material (e.g., plastic).

It should be appreciated that design variations are possible. For example, various types of connectors may be employed to hold two components of a housing together in a closed position. There may be no hinge between the two components of the housing if an appropriate fastening system is used. For example, the two components might have two or more opposed detents that fit into two or more opposed notches. The housing may consist of only one piece or it may consist of two or more pieces, and need not be in a clamshell configuration. Also, the wire-receiving groove can be defined be in only one of two facing components. The port pin may be in any of several configurations so long as it is sufficiently electrically conductive and has sufficient mechanical strength and a sufficiently sharp point or edge to pierce the insulation of an electrically wire. For example, the port pin need not have outer or inner cylindrical surfaces that are circular in cross section, but could have other cross-sectional shapes. And various other pin configurations could be used to facilitate the attachment of an electrical lead to a port pin; for example, a port pin could define a probe-receiving opening that extends generally radially rather than axially.

Although the invention has been described in connection with specific illustrations, it will be understood that the invention is not limited to the views shown. On the contrary, the invention is intended to encompass all modifications, alternatives, and equivalents as may be included within the spirit and scope of the invention, as defined by the appended claims.

1. An apparatus to provide access to the electrical conductor of an insulated wire, comprising:
a housing, wherein the housing defines a port; and
an electrically conductive port pin configured for insertion into the port to puncture insulation of a wire attached to the housing and configured to connect to an electrical test lead.

2. The apparatus of claim 1, further comprising a fastening element, wherein the fastening element is operable to maintain the housing in a closed position.

3. The apparatus of claim 1, wherein the housing is of a generally clamshell configuration.

4. The apparatus of claim 1, wherein a port pin defines a socket that is sized and shaped to receive at least a portion of an electrically conductive test probe to electronically couple the test probe with the wire.

5. The apparatus of claim 4, further comprising a non-conductive capping device configured to be received by the socket.

6. A method for accessing an electrically conductive portion of a wire the method comprising:
attaching a testing device to a wire, the testing device defining an access port aligned with the attached wire;
inserting a port pin into the access port to a position where the port pin makes electrical contact with an electrically conductive portion of the wire; and
electrically connecting a test instrument with the port pin to establish electrical connectivity between the test instrument and the electrically conductive part of the wire.

7. The method of claim 6, further comprising:
disconnecting the test instrument from the port pin; and
removing the port pin from the port.

8. The method of claim 7, wherein the test instrument comprises a test probe; and further comprising connecting the test instrument to the port pin by contacting the test probe with the port pin.

9. The method of claim 6, further comprising securing the testing device to the wire with a fastening device.

10. The method of claim 9, wherein the fastening device comprises a screw.

11. A system for testing wires, the system comprising:
a wire comprising a metal conductor and a sheath of insulating material; and
a testing device operable to be attached to the wire and provide access to the metal conductor through a port, wherein the port extends through a portion of the testing device.
